(19) United States
(12) Patent Application Publication
(10) Pub. No.: US 2017/0358011 A1
(43) Pub. Date: Dec. 14, 2017

(54) SYSTEMS AND METHOD FOR ACHIEVING REDUCED LATENCY

(71) Applicant: Purch Group, Inc., New York, NY (US)

(72) Inventors: Reda Guermas, San Ramon, CA (US); John Potter, Palo Alto, CA (US); Marc Ropelato, West Haven, UT (US); Adam Lauper, South Jordan, UT (US); Ganesh Sundar, Piscataway, NJ (US)

(21) Appl. No.: 15/688,025

(22) Filed: Aug. 28, 2017

Related U.S. Application Data
(63) Continuation of application No. 15/591,912, filed on May 10, 2017.
(60) Provisional application No. 62/334,234, filed on May 10, 2016.

(51) Int. Cl. G06Q 30/02

(52) U.S. Cl. CPC G06Q 30/0275

(57) ABSTRACT

Response latencies in a system are reduced by performing a plurality of auctions in parallel using respective processing threads. An ad call associated with an impression for a webpage requested by a user computer is received by the system. Impression information is obtained based on the ad call, which is then used to determine a subset of multiple potential impression providers that are to participate in an auction for the impression. Behavior models may be used to determine the subset, while floor or reserve price models are used to set a floor/reserve price for each potential impression provider in the subset. Bid requests are sent out in parallel to the subset of potential impression providers using the respective floor/reserve prices, with a thread allocated to each bid request. The models can be further trained on information obtained from the received bid responses and impression information.

### CROSS REFERENCE TO RELATED APPLICATIONS

This application is a continuation application of U.S. patent application Ser. No. 15/591,912, filed May 10, 2017, which claims the benefit of U.S. Provisional Application No. 62/334,234, filed May 10, 2016, both of which are hereby incorporated by reference herein in their entirety.

### BACKGROUND OF THE INVENTION

### 1. Field of the Invention

Various embodiments of the present invention generally relate to systems and methods for achieving reduced latencies in real-time bidding systems.

### 2. Description of the Related Art

Conventionally, website content providers (“publishers”) sell space (“impressions”) on their webpages, which can be purchased by advertisers for the placement of advertisements. Demand-side platforms (“DSP”) and supply-side platforms (“SSP”) are frequently used to connect advertisers with content providers. Using real-time bidding (“RTB”) between DSPs and SSPs, advertisers bid on impressions and the winner fills the impression with their advertisement. The RTB process can be automated through programmatic buying.

As a way to maximize income, publishers can sell impressions using a so-called “waterfall” process. In the waterfall process, potential advertisers are sorted based upon their respective floor prices, and impressions are then offered to the potential advertisers based upon their respective floor prices, from highest to lowest. For example, a first advertiser with the highest floor may first take a portion of the total inventory. The remaining inventory is then offered to the next-highest potential advertiser, and so on, until all of the impressions have been sold. However, each successive bid introduces a corresponding delay in filling an impression. If the bidding process takes too long, delaying the loading of the advertisement, an impression can be lost, which is a wasted resource for both the publisher and the potential advertisers. Hence, speed in the bidding process is important, and managing the timeliness of the bidding process is therefore of importance in the industry. Thus, a need exists for an improved computer implemented system that reduces latency in the delivery and loading of advertisements.

Another problem with the waterfall process concerns the updating of the floor prices. The analysis for determining floor prices is based upon past performance and a prediction of each advertiser's future performance. Once this analysis has been done, the provider must manually update the floors for each advertiser. This process is time-consuming and potentially inaccurate since it treats all impressions equally. Thus, a need exists for an automated process that, unlike prior manual processes, may take into consideration aspects of individual impressions.

### SUMMARY

Various inventive aspects are reflected in the embodiments disclosed herein. Although certain aspects are discussed in connection with different embodiments, it should be appreciated that aspects may be combined into the same embodiment. In one aspect, response latencies in a system are reduced by performing a plurality of auctions in parallel. In one embodiment, an ad call associated with an impression for a webpage requested by a user device is received by the system. The ad call is used to obtain impression information concerning the impression. The impression information is then used to determine a subset of potential impression providers that are permitted to participate in an auction for the impression. A floor or reserve price for each potential impression providers in the subset is determined, bid requests for the subset of potential impression providers are generated using the respective floor or reserve prices, and then the respective bid requests are issued in parallel to each of the subset of potential impression providers. Bid responses are received from at least a portion of the subset of potential impression providers in response to the bid requests, which are used to determine a winning bid. The winning bid is used to render an ad tag, and the ad tag is then forwarded to the user device.

In another aspect, parallel processing threads are used in specially programmed computers (e.g., servers) to reduce latencies. In one such embodiment, a system for conducting a real-time auction among multiple potential impression providers is disclosed, which identifies an ad to be served with digital content via a network. The system includes a server having one or more processors. The processors are programmed to determine a subset of the multiple potential impression providers to participate in the auction. The processors then determine a floor price for each of the subset of potential impression providers. Using the processors, multiple threads are run in parallel, each thread, for an individual one (or, in alternate embodiments, more than one) of the potential impression providers, generating and providing in parallel to each individual potential impression provider a bid request and processing a bid response (if any) from the potential impression provider. As will be appreciated by those skilled in the art, employing such multiple parallel threads on a potential impression provider-by-potential impression provider basis provides particular advantage in terms of processing speed of the overall system. The system then determines a winning bid from the received bid responses, generates an ad tag based on the winning bid, and then provides the ad tag to a user computing device for rendering the ad. Such parallel threads may be incorporated into each of the embodiments discussed herein.

In yet another aspect, a system and method is disclosed for performing a unified auction to fill an impression in connection with serving a webpage requested by a user computing device. Such integrated system and method presents a new technical paradigm as compared to traditional ad serving technologies. In one embodiment, an ad call associated with the impression is received. Impression information is obtained based on the ad call and used to select one or more potential header bidders for the impression. Code is then provided to the user computing device to be used in connection with requesting bids for filling the impression from the potential header bidders, wherein this code includes an indication of the potential header bidders and an indication of where to send any responses to the bid requests. As such, the code provided to the user computer device fundamentally differs from that traditionally used in serving an ad and permits fundamentally different operation. The impression information is also used to determine a subset of multiple potential impression providers to participate in a competitive auction for filling the ad impression, in which bid requests for the subset of potential impression providers are generated and then issued in parallel to the subset of potential impression providers, which further improves the operation and reduces latency of the system. Bid responses are received from at least a portion of the subset of potential impression providers in response to the bid requests and from which is determined a winning bid based on bid responses received from both the subset of potential impression providers and the header bidders. An ad tag is generated based on the winning bid to render an ad on the user computing device.

In yet a further aspect, a system and method is disclosed for integrating both content delivery and advertisement management, which can be used when serving content (e.g., a webpage) and advertisements to user computing devices via a network, such as the Internet. Such integrated system and method presents a new technical paradigm (and thus system) as compared to traditional ad serving technologies. In a specific embodiment, a request is received for content from a user computing device. Multiple potential templates or layouts are associated with the content, with the templates including at least a first template having one or more impressions and a second template having one or more impressions. The first template is different from the second template, for example, having different number, placement, size and/or type of one or more ads (though some ads may be the same). For each potential template for the content, an aggregate potential value is estimated. To do so, each impression in the respective template is processed to determine a maximum possible return. To determine the maximum possible return for an impression, a subset of potential competitive impression providers is identified that will be allowed to bid on the impression. A floor price for each of the subset of potential impression providers is determined, and multiple threads are then run in parallel, with each thread, for an individual one of the subset of potential competitive impression providers, generating and providing to the individual potential competitive impression provider a bid request and processing a bid response, if any, for the impression. Also, expected values of non-competitive impression providers, if any, are determined for the impression. Such non-competitive impression providers can include, for example, direct sales advertising impression providers, lead-generation offers, e-commerce offers or the like. A winning impression provider from the received bid responses and the expected values of the non-competitive impression providers, if any, is then determined. One of the potential templates is then selected based on comparing (e.g., selecting the greatest of) the estimated values of the potential templates. At least one ad tag for the one or more impressions in the selected potential templates is rendered based upon a bid response from the one or more corresponding winning impression providers, and content description according to the selected one of the potential templates is generated, with the content description including the ad tag. In other variations, multiple ad tags can be generated that are included as part of the content description, with each ad tag corresponding to a bid response from a winning impression provider for each respective impression in the selected template. The content template is then provided to a user computing device for rendering the content and at least an ad corresponding to the at least an ad tag.

In some embodiments, determining a subset of multiple potential impression providers for an impression includes running, for multiple (or each) of the multiple potential impression providers, a corresponding behavior model for that potential impression provider to determine a probability of that potential impression provider submitting a bid and/or an estimate of the potential bidding price for the subject impression by the potential impression provider (e.g., an estimation of what the potential impression provider would bid for the subject impression). In a further variation, information obtained from the bid responses and the impression information can be used to train the behavior models. Specific embodiments may include a profile database that is used to store information used by the models, and information obtained from the bid responses and the impression information can be used to update this profile database.

In certain embodiments, generating bid requests for an impression for the subset of potential impression providers includes running, for multiple (or each) of the subset of multiple potential impression providers, a corresponding floor or reserve price model for that potential impression provider to estimate a price to be bid for the subject impression by the potential impression provider. This estimated (or predicted) bidding price can then be used to generate the bid request. Information obtained from the bid responses and the impression information can be used to train the floor or reserve price models. Additionally, information obtained from the bid responses and the impression information can be used to update the profile database used by the floor or reserve price models.

In certain embodiments, the impression information can be used to determine an expected value of a non-competitive bid for the impression. In such embodiments, the non-competitive bid can be used as a winning bid if the expected value of the non-competitive bid exceeds the received bid responses from the subset of potential impression providers. In certain other embodiments, the non-competitive bid is used despite having a lower expected value than a competitive bid based upon parameters of the non-competitive campaign.

In certain embodiments, obtaining the impression information comprises obtaining taxonomy information concerning the impression.

In further embodiments, the results of bidding can be used to set the floor or reserve price in a secondary auction to determine the winning bid. For example, a highest bid from the bid responses received from one or more of potential impression providers, header bidders and non-competitive bidder can be determined. This highest bid is then used to set a floor or reserve price in the secondary auction, and results from the secondary auction are the used to determine the winning bid.

### BRIEF DESCRIPTION OF THE DRAWINGS

The various aspects and embodiments disclosed herein will be better understood when read in conjunction with the appended drawings, wherein like reference numerals refer to like components. For the purposes of illustrating aspects of the present application, there are shown in the drawings certain embodiments. It should be understood, however, that the application is not limited to the precise arrangement, components, processes, algorithms, features, embodiments, aspects, and devices shown, and the arrangements, components, processes, algorithms, features, embodiments, aspects and devices shown may be used singularly or in combination with other arrangements, components, processes, algorithms, features, embodiments, aspects and devices. The drawings are not necessarily drawn to scale and are not in any way intended to limit the scope of this invention, but are merely presented to clarify and illustrate embodiments of the invention. In these drawings:

FIG. 1 is a schematic diagram of an advertising management platform according to one embodiment of the present invention;

FIG. 2 is a flowchart for the advertising management platform depicted in FIG. 1 according to one embodiment of the present invention; and

FIG. 3 is a workflow diagram according to one embodiment of the present invention;

FIG. 4 is a workflow diagram according to an alternate embodiment of the present invention;

FIG. 5 is a schematic diagram of an advertising management platform according to an alternate embodiment of the present invention;

FIG. 6 is a flowchart for the advertising management platform depicted in FIG. 5 according to one embodiment of the present invention; and

FIG. 7 is a workflow diagram illustrating avoidance of adblocking according to an embodiment of the invention.

### DETAILED DESCRIPTION

The following describes illustrative advertising management platforms according to various embodiments of the present invention. As will be understood by those skilled in the field, such embodiments provide several advantages over known systems and methods used for serving online advertisements. In the following, the terms “advertiser” and “bidder” are used interchangeably, and refer to, inter alia, any entity that may submit a bid in an auction for an impression. For example, in one aspect, to help reduce the latency and delay in filling an impression (serving an ad), embodiments submit an impression for bidding to all potential advertisers (or bidders) in parallel (i.e., simultaneously or near simultaneously), rather than in a sequential “waterfall” manner. One such implementation utilizes threads running in parallel on one or more servers, with a thread allocated for each bid request/receipt with a potential advertiser. In another aspect of certain embodiments, the platform performs pricing optimization in connection with submitting such parallel bid requests. For example, as described in greater detail below, each bid request may contain an indication of a computed floor or reserve price for the associated bidder. Such parallel bid requests may represent an auction, with the bidder responding with the “winning” bid (e.g., highest bid subject to ad quality rules) placing an ad for the impression. In yet another aspect, certain embodiments perform auction optimization. For example, to further avoid or reduce delays in the auction process, the platform submits bid requests only to those bidders who are identified as being relatively more likely to submit a winning (successful) bid for the impression at issue. This determination may be based on any number of different models, but preferably takes into consideration as inputs the bidder's past bidding history, data regarding the impression being bid upon (such as ad type, content subject, time of day, web site, page ID, ad size, location on page, etc.) and anonymous web user data of the user who will view the impression (such as geographic location, browser type, user device type, operating system, platform, etc.). By way of further example, in various embodiments the selection of bidders can also take into account the expected latency of a particular bidder based upon the characteristics of the user session. For example, if a particular bidder has a history (as reflected in a profile database) of responding slowly to requests for bids on European impressions, but quickly for bids on U.S. impressions, then the bidder may be left out of European auctions so as to reduce latency in the bidding process.

As will also be appreciated by those skilled in the field, the illustrative advertising platforms and features of them described herein may be implemented as distinct systems or may be integrated with other systems, such as SSPs, DSPs, advertising exchanges, publisher content delivery systems (“CDSs”), or the like. For example, in one embodiment described herein, the advertising management platform is integrated with a CDS, which provides for optimization not only of the advertising itself (e.g., selection of the individual ads), but also of the content into which the advertisements are integrated, with attendant technical and business benefits. It will be further appreciated that the various embodiments are not restricted only to conventional Internet content, but can also be used in other contexts, such as serving ads in connection with or within mobile applications and the like. Additionally, it should be understood that the various embodiment systems and methods can support web content, content for applications and/or advertisements that includes multimedia content in addition to conventional “static” digital content, including audio-video content, interactive content and other types of digital content.

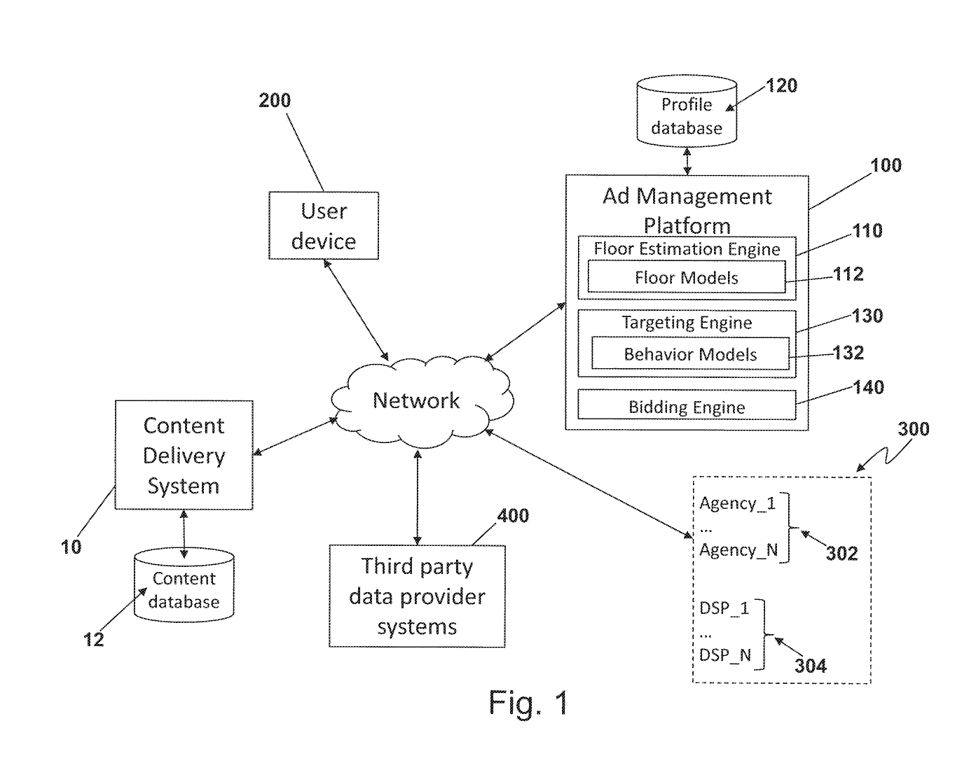

Certain embodiments will now be described in greater detail with reference to the drawings. Turning first to FIG. 1, end user (or consumer) devices 200 (such as computers, smart phones, mobile devices or the like), CDS 10, which, for example, serves webpages, and an advertising management platform 100 are coupled to and in communication with each other via a network, such as the Internet. It will be appreciated, however, that the various embodiments are not restricted to Internet content but are also applicable to other areas, such as content on mobile devices and the applications thereon. In the present embodiment, the device 200 is an end-consumer computer, such as a desktop, laptop, tablet, smart phone, television or the like, with an Internet browser (e.g., Microsoft Explorer, Google Chrome, Apple Safari, etc.), requesting content from the CDS 10. Although a single end-user device 200 is shown, it will be understood that in practice multiple end-user devices 200 are connected to the network and that the ad management platform 100 performs the processes described herein for the providing of content and advertisements to each end-user device 200, including performing such processes in parallel as needed. The CDS 10 may be, for example, one or more web servers or other digital computing device(s) (including associated storage and databases), and advertising management platform 100 may similarly be one or more specially-programmed servers and related storage and databases also coupled to the network. It should be understood that the term “database” can include any computer system for storing information, such as Hadoop, other noSQL databases, etc.

In general, the user device 200 may issue a webpage request, or similar request for content, to the CDS 10 requesting content from a provider, such as in the form of webpage content or in-application content. The CDS 10 provides the requested content (e.g., webpage content) to the user device 200 in response to the content request, e.g., a webpage request. As described herein, advertising management platform 100 determines which ad(s) are served to the user device 200 in connection with the delivery of content to it. To do so, advertising management platform 100 is also in communications with (e.g., via the Internet, WAN, LAN, or otherwise) potential impression provider systems 300. The impression provider systems 300 are potential bidders and can include, for example, one or more advertising agencies (Agency_1 to Agency_N) 302 and DSPs (DSP_1 to DSP_N) 304. The potential impression provider systems or bidders 300 may bid on impressions (as permitted by the platform 100), and provide an advertisement (also termed a “creative”) after winning an auction for an impression. The advertising management platform 100 thus considered is one that interfaces with both the CDS 10 and impression provider systems 300 to determine which advertisements to provide to the end user device 200.

It should be understood that although FIG. 1 illustrates a single end user device 200, the embodiments herein are applicable to serving content and advertisements to multiple users. Similarly, although the advertising management platform 100 is illustrated as interfacing with a single CDS 10, it is to be understood that one or more advertising management platforms 100 may interface with one or more CDSs 10 and thus serve advertisements for multiple systems (and, e.g., multiple webpages).

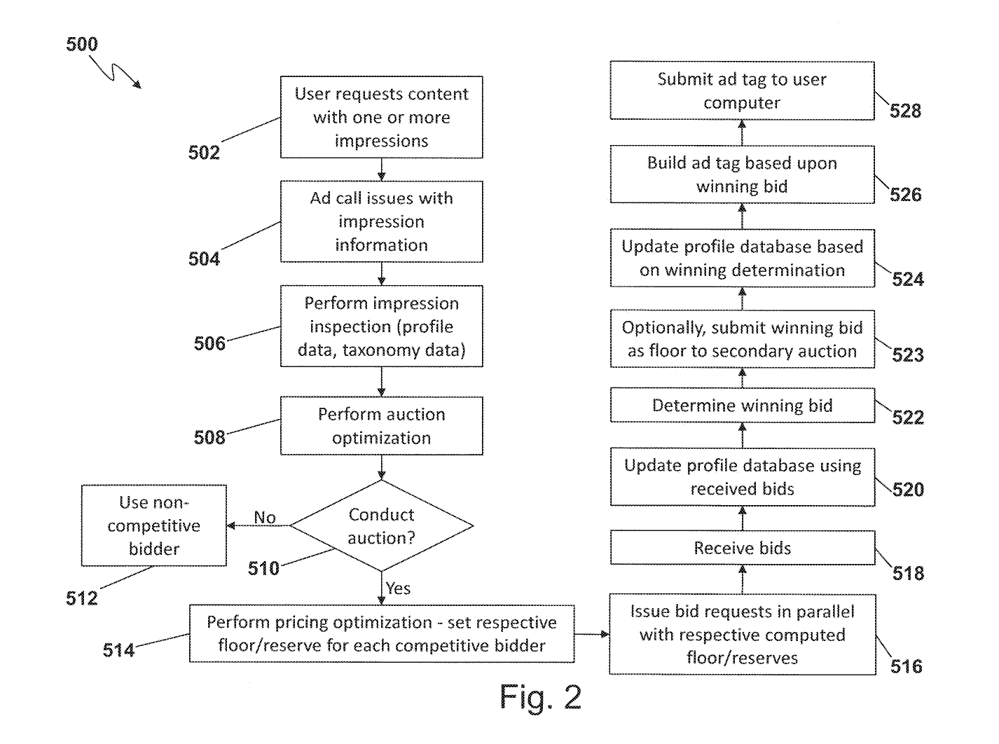

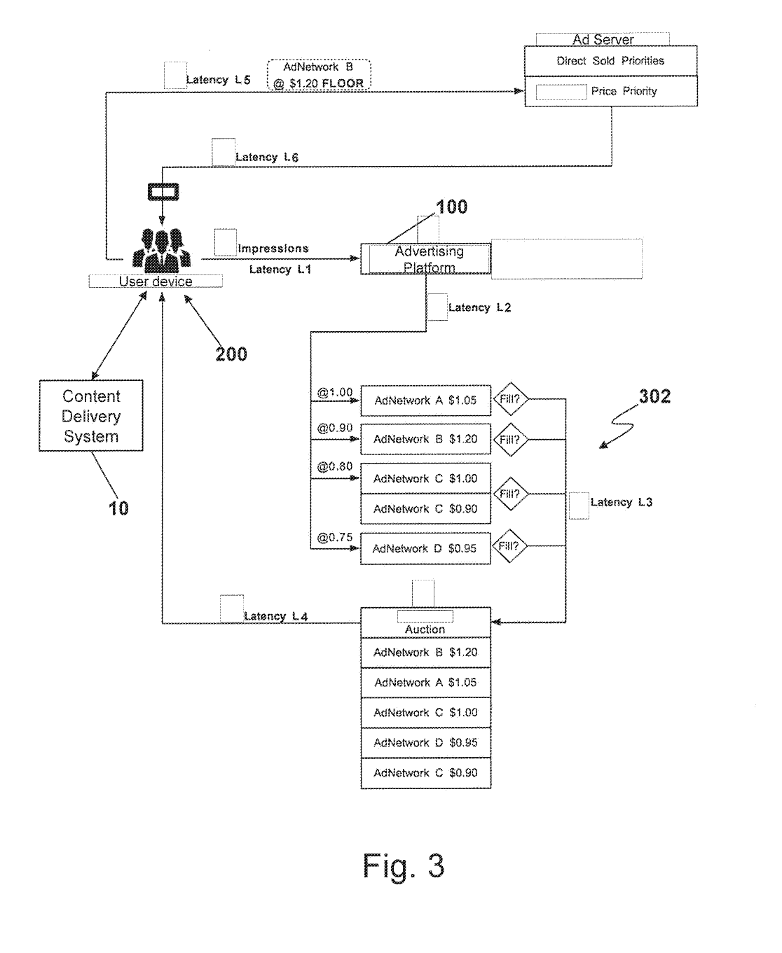

The operation of the foregoing embodiment will now be described in greater detail with reference to FIGS. 2 and 3 and continued reference to FIG. 1. Beginning with step 502, in the context of delivering webpage content, when a user visits a webpage hosted, for example, by CDS 10, the user device 200 sends a corresponding webpage request to the CDS 10. In response to receiving the webpage request, in step 504, the webpage code (e.g., HTML, JavaScript or the like) makes an ad call to fill an impression associated with the requested webpage. The ad call includes impression information, which may include information concerning the end user, the user device 200 and/or the impression, such as one or more of the Internet Protocol (IP) address of the user device 200, the page URL of the requested being served, the USER_AGENT of the web browser of user device 200, the resolution of the web browser of user device 200, cookie information stored in user device 200 concerning the platform 100 domain, the time-zone of user device 200, the type of ad (or “ad unit”) or the location of the advertisement on the web page (which may be indicated by a “placement ID”), custom key-value information, referrer URL, user locale and information derivable therefrom, such as content taxonomy information. The impression information that is provided in or obtained from the ad call can vary, for example, depending upon what information is used by models 112, 132 of platform 100, which are discussed in more detail below. Issuing the ad call introduces a first latency L1.

In step 506, the advertising management platform 100 receives the ad call containing the impression information and performs an impression inspection to extract, determine or both related features. As described in greater detail below in connection with the example ad call pipeline, this includes the platform 100 retrieving (e.g., from local databases) user profile information and taxonomy data related to the impression and populating the impression request with taxonomy data, HTTP request data, user data (e.g., IP address, country, state, site, designated market area (“DMA”)), and device information (e.g., operating system, web browser, device type and the like). By way of example, the IP address in the impression information can be used to determine the geographical location of the computer 200, from which can be determined, for example, the related country, state, city, zip code and DMA. The page URL in the impression information can give the domain and site that the user device 200 is visiting, and by using the URL, the taxonomy of the content of the page can be determined; additionally, a unique page ID can be determined based upon the URL. The USER_AGENT information can be used to determine the web browser being used on user device 200, as well as the operating system and the type of device 200 (e.g., mobile, desktop, tablet, game console or other). Cookie information can be used to determine a unique visitor ID associated with the user device 200, and this unique visitor ID can then be used to lookup historical targeting information in profile database 120 from which further information can be obtained. User locale in the impression information can be used to determine the language of the web browser used on user device 200.

Preferably, and depending on, for example, the type of content and whether the advertisements will be integrated “natively” or not, by this point in the overall process, the webpage is already being built and content provided, as opposed to delaying the build for the determination of which advertising content is to be served. It will be appreciated, for example, that if the advertisement is integrated “natively” into the content, then the webpage typically cannot be constructed until it is known which ads are to be integrated therein. With video, however, unless the ad runs before the video, it is typically not necessary to wait to determine the content of the ads embedded in the video to start serving the video.

In step 508, the advertising management platform 100 performs auction optimization—namely, determining whether an auction should be held and, if so, which of the potential impression provider systems 300 will be permitted to participate in the auction for the impression and thus receive a bid request. This determination can be based upon, for example, the attributes or features obtained from the impression information, historical information stored in the platform 100, or both, including, without limitation: hour of the day of the user device 200 request, operating system of the user device 200, device type of user device 200, browser type of user device 200; country, state and city locations of user device 200; impression size; site of request content and content category. It should therefore be understood in the following that a “feature” can be any data useful as an input into a model 112, 132, including, for example, information both directly present in the impression information, information derived from the impression information, and information obtained from databases concerning, for example, user device 200, bidders 300 and the subject impression. As described in more detail below, the platform 100 executes models 112, 132, which are used to predict a subset of bidders 300 that are deemed most likely to provide a top bid given various features, including, for example, historical bidding information of the bidders 300, features concerning the user device 200, and the subject impression. The base set of potential impression providers 300 used to determine this subset of bidders 300 can include, for example, all DSPs 304 and advertising agencies 302 integrated into the platform 100, all individual advertisers (e.g., Amazon) integrated into the platform 100, and native offers, such as offers from the owners of the CDS 10 or platform 100 and other non-competitive bids. The models 112, 132 may be implemented by way of code, data or combinations thereof that are stored in a suitable persistent storage system and that can be regularly loaded into the memory of each of the server(s) to make them immediately available to the advertising management system 100 for use in its algorithms. In a specific embodiment, the models 112, 132 are implemented as function parameters that are input into a function during evaluation, and can be stored as files in the persistent storage. The platform 100 can check the respective files at periodic intervals to determine if the model 112, 132 has changed and, if it has, load the new version of the model 112, 132 and discard the old version.

To facilitate bidder 300 determination in step 508, the platform 100 preferably includes a profile database 120 and a targeting engine 130. The targeting engine 130 can be provided by, for example, program code configured to provide the methods and functions discussed herein. The profile database 120 stores information about each of the potential impression provider systems 300, including, for example, past bidding history. For purposes of the discussion herein, it is assumed that profile database 120 also stores information about user devices 200. It will be appreciated, however, that more than one database may be used to store this information. Bidding history can include, for example, all information about each impression, user and user device 200 associated with the impression, the impression information (including information about the content (e.g., web page)), and all information about the bidding landscape, such as the number of bidders, the respective bid amounts (and associated metrics that can be calculated therefrom), the winning bid, the amount and timing of the bid responses and from who received, etc. In addition, the profile database 120 can store information about the user and user device 200 associated with each impression, which can be aggregated with the impression information to provide additional information or features about the user and user device 200 and to assist in selecting potential impression providers 300 for bidding. It will be appreciated that the profile database 120 could, in fact, be partitioned into multiple databases, each handling a certain type of information; for example, one database could be in relation to DSPs 304, while another could be in relation to user devices 200. In the following discussion, however, a single profile database 120 is considered containing all such information.

The targeting engine 130, which may be a program running on the platform 100, includes (effects) one or more behavior models 132 to model the expected bidding behavior of the potential impression provider systems 300 to select a subset of the universe of potential provider systems 300 that are relatively more likely to submit a “winning” bid. As will be appreciated by those skilled in the field, by reducing the number of potential bidders, the system 100 further may decrease potential latency and increase the likelihood of promptly serving content and the advertisement. The targeting engine 130 may use various features obtained from, for example, the impression information, information stored in the profile database 120 and information provided by a taxonomy service. The taxonomy service provides contextual categorization of the content (e.g., the webpage containing the impression) being served to user device 200. The taxonomy service may be a program executing within the advertising management platform 100 that retrieves information from a taxonomy database, or may be provided by a separate data management platform (“DMP”). For example, if a DMP is used, then the taxonomy information can be obtained by the platform 100 making an API call to the DMP. Alternatively, the information from the DMP may already be stored within the platform 100 in a suitable database. The provided taxonomy information can include, for example, the subject or subjects of the content (e.g., as determined by text analysis); particular products mentioned; generic product categories mentioned (e.g., cell phones, televisions, automobiles, etc.); companies mentioned, etc. These categorizations can be subject to specific rules based on frequency, subject weight, etc. In addition, information about the interest of the user 200 or interaction with content that has similar categorizations can also be provided by DMPs and used as features for auction optimization as described herein.

The behavior models 132 implemented in the targeting engine 130 are used to determine which of the potential bid providers and associated systems 300 may be allowed to participate in such auction. In the platform 100, as a specifically programmed computer (server), each behavior model 132 preferably runs asynchronously within its own thread or process. The behavior models 132 may be as simple or as complex as necessary or desired to model the behavior of the corresponding potential bid provider system 300 in relation to the impression inspection to determine if that potential bid provider system 300 should actually participate in an auction for the impression. Thus, any model 132 may use as model parameters or features any one or more of the data available, including impression information and any features derived therefrom, information regarding the user or user device 200, information concerning the potential bidder 300 being modeled (such as may be stored in profile database 120), etc. Any given model 132 may be applied to any one or more potential provider systems 300; for example, each potential bidder 300 may have a unique associated model 132; alternatively, providers 300 of a certain class (e.g., DSPs 304) may be collectively modeled using a single model 132. A behavior model 132 may indicate, for example, the likelihood that a corresponding bid provider system 300 will actually bid on the impression and/or an expected bid (e.g., based on the past bidding of the potential bidder 300 on comparable impressions, where comparability may be determined by, inter alia, comparing impression information for the subject impression with impression information stored in the profile database 120 for the provider 300).

For example, if it is known that one of the advertising agencies 302 will only bid on impressions originating within Texas (e.g., the impression information indicates that the consumer computer 200 is in Texas), then this feature concerning user device 200 can be used as an input into one possible behavior model 132 in the targeting engine 130 for such an agency 302, and the behavior model 132 could include logic along the lines of: if the impression information indicates that the impression originates in Texas, then indicate that a bid is likely; otherwise, indicate that a bid is unlikely. The behavior model 132 could also indicate a likely bid for this advertising agency 302 based upon, for example, a running average of bids placed by the advertising agency 302 for impressions similar to the subject impression. For example, a bid estimate could be determined based upon a previous bid from the provider 300 for a similar user (e.g., similar geo-location) for similar content (e.g., based on taxonomy information) and a similar impression (e.g., ad unit, size, page position, number of impressions on the page, etc.). Alternatively, the use of any suitable machine-learning algorithms may be used for the behavior model 132 of an impression provider 300, based upon the most current profile data 120 available for the impression provider 300, to determine the likelihood that the impression provider 300 will bid on the impression and the expected amount of the bid.

By way of another example, as indicated above, the behavior model 132 may be based upon a machine-learning algorithm using certain features obtained from the impression information, profile database 120 or both, such as: hour of the day, site, country, state, city, impression size, end-user, device type, operating system and browser. The behavior model 132 can be trained at predetermined intervals, such as once every day, using the most recently obtained data, which may be stored in profile database 120, since the last training session to cause the behavior model 132 to predict the related bidding behavior of potential bidder 300, such as highest bid. The behavior model 132 can be fine-tuned to minimize the error in doing such a prediction, and can thereafter be applied to all following impressions, with the behavior model 132 predicting the possible highest bid on any given impression based on, for example, its features and data from the previous impressions to determine an expected bid amount.

By way of a specific example, each behavior model 132 can be formulated as a multiclass classification learning problem where each potential bidder 300 is considered a different “class,” with a one-versus-all classifier being trained that learns a different classifier for each class—i.e., potential bidder 300. For any given impression, the classifier can return a probability of the corresponding bidder 300 bidding on that impression. Then, these probabilities can be sorted, with some number k of the top bidders 300 with the highest probabilities being allowed to participate in the auction. It will be appreciated that the data to learn from typically cannot have the model 132 applied to it, since information concerning how each bidder 300 reacted to an impression is needed, and such information would not be available if the bidder 300 is eliminated by a model 132.

By way of further example, non-limiting features used to train a behavior model 132 can include hour of the day, site, country, state, city, domain location of the requested content, content category, impression size, existence/placement of other impressions, device type, operating system and browser. For training purposes, a random percentage of the impressions, such as 15%-25%, more preferably 20%, may be selected in which all potential bidders 300 are allowed to participate in the auction for the impression, and the corresponding bidding data collected from these selected impressions can later be used to train behavior models 132. Subsequently, the behavior models 132 can then be applied to the remaining percentage of impressions (e.g., 80%) to select only those potential impression providers 300 that are most likely to submit a bid.

By way of continuing example, when training, the classification is made cost-sensitive, so that if a bidder 300 wins the bid the cost is 0; if the bidder 300 bids but doesn't win the cost is 1.0, and if the bidder 300 doesn't bid at all the cost is 2.0. Of course, other suitable values are also possible for the cost function, these simply being illustrative. The behavior model 132 can be formulated as a regression problem, with each bidder 300 having a regression problem being solved against every other bidder 300. An optimization problem can be solved for each bidder 300, e.g.:

x*=argminₓ(f(x)+λ∥x∥²₂

where x* is the solution to the regression problem, f(x) is a function of the model parameters x that are to be minimized to obtain a best fit for each class (i.e., bidder 300), and the λ∥x∥²₂ term is a regularization function that is used to minimize over-fitting. The function f(x) can be, for example, a square loss function, e.g., f(x)=λ∥Ax−b∥²₂, where A is an m×n feature matrix of m impressions lying in an n dimensional space, and b is the output vector, which can correspond to the cost associated with the corresponding bidder 300. The above algorithm can be solved, for example, by using stochastic gradient descent with any suitable fast out-of-core machine learning system. Since stochastic gradient descent may take a lot of time to converge, a second-order approximation, such as L-BFGS (limited-memory Broyden-Fletcher-Goldfarb-Shanno (BFGS) algorithm), may be used after the stochastic gradient descent algorithm finishes a predetermined number of passes on the learning data.

The targeting engine 130 may also include a behavior model 132 for the user device 200, which can be used to estimate a potential value of the user device 200 in relation to filling the impression with an offer from a source other than the competitive bids received from the potential impression provider systems 300, such as from direct sales, e-commerce sales, lead generation or the like.

The targeting engine 130 may also select bidders 300 based upon targeting rules logic, which can be set by a user using a campaign management console of platform 100. Hence, bidders 300 can be targeted not only upon their expected bid performance, but also upon advertising rules determined by a user managing the advertising campaign. Examples of advertising rules include, for example, frequency capping (limiting the exposure of a particular user 200 to a particular ad), geographic targeting, content targeting, etc. The targeting engine 130 preferably only runs the behavior models 132 for bidders 300 that are conformal to the user-selected advertising rules.

Having applied the behavior models 132 to the potential provider systems 300, the targeting engine 130 preferably selects a subset of competitive bidders 300, conformal to the advertising rules implemented within targeting engine 130, to which a bid request may be sent. Such subset may be determined, for example, by selecting a fixed number of participants 300, such as three, having the highest expected bids; participants in the top quartile of expected bid values, or the like. Thus, even though an auction is performed, it may be performed with a subset of the potential impression provider systems 300, thereby potentially significantly reducing the number of participants in the auction and the corresponding probability of the auction delaying the filling of the impression, while increasing the likelihood that all bid responses are received within a relatively shorter time period (and before any bid request times out, as discussed below).

In step 510, the platform 100 may then determine whether an auction should be held for the impression. If, based upon the targeting engine 130, the platform 100 determines that an auction using competitive bidders 300 should likely yield more revenue than the non-competitive bidders, such as direct sales (while also allowing all direct sales orders to be timely filled), then the platform 100 proceeds to step 514 to begin the auctioning process. Otherwise, in step 512, the platform 100 fills the impression with a non-competitive bid, such as a direct sales advertisement, an e-commerce advertisement, a lead-generation offer or the like. As noted, when determining whether to conduct an auction or fill an impression through direct sales, the platform 100 may consider the advertising number of direct sales to be filled and, e.g., if such number is above a threshold (which may change, for example, in relation to the amount of time to the end of the direct sales campaign), may fill the impression with the direct sales.

In step 514, once the platform 100 determines which provider systems 300 will receive bid requests, it then performs pricing optimization—namely, determining the floor or reserve price for each of such competitive bidders 300. The platform 100 includes a floor estimation engine 110, which may be implemented as a module in platform 100. The floor estimation engine 110 can use, for example, a machine learning floor model 112 that is trained on past impressions to determine the floor price of new impressions of “similar” features. Although the present discussion is in relation to bidding floors, it will be appreciated that here, and throughout this disclosure, reserve prices may also be calculated in addition to, or instead of, floor prices, depending upon the type of auction being performed, the related bidder(s) 300, etc. Hence, in the following discussion, the term “floor price” should also be understood to include the term “reserve price,” unless indicated otherwise from context.

It will be appreciated that, like the behavior models 132, any suitable algorithm may be used for the floor models 112, such as the average winning bid over a predetermined number of previous days or over a number of impressions for the content (e.g., webpage). The floor models 112 for establishing dynamic floors (or reserve prices) can run from memory on the servers of the ad management platform 100. For some, or all, impressions, additional floor information may come from targeting a particular bidder 300 against that impression at a set cost per thousand (“CPM”), which can create a floor for the auction. Such targeting can be part of the campaign management aspect of the platform 100 and set by a user using the advertising campaign management console of the platform 100. Hence, similar to the targeting engine 130, the floor estimation system 110 may use features from the impression information (as potentially augmented by any other additional information or features about the user and user device 200 stored in profile database 120 or otherwise available to the platform 100), information from the profile database 120, and the taxonomy service to model the anticipated bids of the selected potential impression provider systems 300 to determine a floor or reserve price for each such potential impression provider system 300, as well as settings indicated by a campaign management console of platform 100. These features are fed as inputs into the floor estimation engine 110, and in particular may be fed as inputs into a floor model 112 corresponding to one or more potential impression provider systems 300.

The floor estimation engine 110 preferably includes a plurality of floor models 112. Each floor model 112 is constructed to model the bidding behavior of one or more of the potential impression provider systems 300 based upon, for example, past behavior as stored in the profile database 120, the subject impression, impression information of user device 200, etc. Each floor model 112 preferably runs asynchronously within its own thread or process, and thus the bidding models 112 can run in parallel with each other. The floor models 112 may be as simple or as complex as necessary or desired to model the bidding behavior of the corresponding potential impression provider system 300 in relation to the impression information to set a bidding floor or reserve for such impression provider system 300, and may employ the same, similar or different algorithms, code or both as used in the corresponding behavior models 132. By way of a specific example, the floor model 112 can be formulated as a regression problem using square loss with an l2 norm, so that the following problem is optimized:

x*=argminₓ(f(x)+λ∥x∥²₂)

where x* is the solution to the regression problem, f(x) is a function of the model parameters x that are to be minimized to obtain a best fit, and the λ∥x∥²₂ term is a regularization function that is used to minimize over-fitting. The function f(x) can be, for example, a square loss function, e.g., f(x)=λ∥Ax−b∥²₂, where A is an m×n feature matrix of m impressions lying in an n dimensional space, and b is the output vector, which can correspond to the highest bid for each impression. The above algorithm can be solved, for example, by using stochastic gradient descent with any suitable fast out-of-core machine learning system. Features which may be extracted from the impression information and used as inputs into the floor models 112 can include, but are not limited to: the time, country, state, city, device type of the originating content request from user device 200; impression size; existence/placement of other impressions; domain location of the underlying content and content category.

In certain embodiments, the targeting engine 130 and the floor estimation engine 110 run in parallel, as separate threads or processes on the server(s) of platform 100 (e.g., the same or different processor), thereby further reducing latency. Alternatively, the floor estimation engine 110 and targeting engine 130 may be integrated into a single model for one or more impression provider systems 300.

Once the floor estimation engine 110 and the targeting engine 130 have completed running their respective models 112, 132 for each of the potential impression providers 300, in step 516, the platform 100 generates and issues the bid requests to the subset of selected bidders 300. The advertising management platform 100 can include a bidding engine 140 that submits the bid requests in parallel to the participating impression providers 300, which introduces another, single, latency L2. The bidding engine 140 can allocate multiple threads so that each bid request runs in its own thread, with the thread handling the sending of a respective bid request and the receiving of a related bid response. Preferably, such allocation is one-to-one for bid requests with respect to threads, but it will be appreciated that the allocation could be greater such that a single thread handles two or more bid requests. The bid requests may include all or a subset of the impression information, and also indicate the respective floor or reserve price computed for each impression provider system 300. Hence, each bid request submitted by the advertising platform 100 can have a different floor or reserve price for the impression for each participating impression provider system 300. Bid requests may be, for example, JavaScript Object Notation (“JSON”) formatted. After submitting the bid requests, the platform 100 then waits for bid responses from the participating impression provider systems 300 (step 518), which introduces another, single, latency L3. The bid responses preferably include a price as well as information regarding the ad (creative), and are preferably compatible with the Open RTB 2.3 specification, as set forth at www.iab.com/guidlines/real-time-bidding-rtb-project (as may be updated or replaced). Bid requests may also include bidder-specific extensions, such as “recommended price,” the recommended price to win the impression, or “screen resolution.” The extensions can allow for custom parameters that the seller wants to send to the buyer to improve efficiency. In generating the bid responses, the participant bidders 300 may utilize their own or third party data sources 400, which may provide further information on the user/user device 200 and/or impression. The platform 100 monitors the time spent after submitting the bid requests, and if an impression provider system 300 exceeds a threshold timeout value, such as 100 milliseconds, that impression provider system 300 is assumed to be non-responsive to the bid request. Hence, the latency L3 should never substantially exceed the threshold timeout value.

For example, with specific reference to FIG. 3, the advertising management platform 100 has determined, based upon the behavior model(s) 132, that four advertising network agencies 302, “AdNetwork A” to “AdNetwork D” are likely to submit the highest bids for the impression, and thus proffers respective bid requests to each of these agencies 302. Further, the floor estimation engine 110 has computed respective floor prices (or reserve prices, if an impression provider 300 is a second auction bidder) for each agency 302, with the highest floor being set for “AdNetwork A” at $1.00, and the lowest floor being set for “AdNetwork D” at $0.75. In an alternative embodiment, the same floor or reserve price may be submitted for multiple or all participating bidders 300. As correctly determined by the targeting engine 130, each agency 302 tenders a bid response, with “AdNetwork A” tendering a bid of $1.05, “AdNetwork B” tendering a bid of $1.20, “AdNetwork D” tendering a bid of $0.95 and “AdNetwork C” tendering two bids of $1.00 and $0.90, corresponding to two different types of content. It will be appreciated that a bidder 300 may submit multiple bids for a single impression. For example, a bidder 300 that conducts a second-price auction may submit its top two bids with the expectation that the bid used for pricing would be the second place bid plus an offset, such as one cent. Although not shown, one or more other potential ad networks (e.g., “AdNetwork E”) may have been omitted from the auction, as determined by the platform 100. Each bid response includes corresponding advertising information.

Turning back to FIG. 2, the bidding engine 140 of platform 100 uses the bid responses (in step 520) to update the profile database 120, thus providing a learning or feedback loop, for the platform 100. Hence, when running, the models 112, 132 effected as part of the floor estimation engine 110 and targeting engine 130, respectively, are able to make use of the most recent and up-to-date information available concerning each potential impression provider system 300, thereby avoiding the need to manually update floor and reserve prices.

In step 522, the bidding engine of advertising management platform 100 reviews the tendered bids and determines the “winning” bid. Such determination may be based on the highest price bid, subject to ad quality or other rules manually established by the publisher and effected by the platform 100, such as whether the user device 200 permits or is compatible with the type of media contained in the ad proposed to be served by the bid. Ad quality rules may be included as part of the advertising rules and logic set by an operator via the campaign management console of platform 100. If a bid is rejected based on the ad quality rules, the next highest bid may be selected, and so forth. Alternatively, the bid request may indicate acceptable parameters of the ad (creative). In the example of FIG. 3, the winning bid is indicated as “AdNetwork B” at $1.20. Once the winning bid is determined, the platform 100 updates the profile database 120 (step 524), thereby providing additional learning, or feedback, to the system 100.

In an optional step 523, the system 100 may cause the winning bid from step 522 to be submitted as a floor or reserve in a secondary auction, thereby allowing various bidders a “last look” to decide if they want the impression at a higher price. Such a secondary auction may include, for example, all or some of the same bidders and/or allow new bidders. For example, the initial ad call may indicate that a secondary auction should be performed. Or, the web page content may include instructions causing the browser of the user device 200 to initiate the secondary auction.

In step 526, a response builder of the platform 100 uses the winning bid, together with its related advertising information, to render an ad tag, which is then forwarded to the user device 200 (step 528) to be included in the content (e.g., webpage) being served to and executed by the user device's browser or application. The response builder may be, for example, program code on the platform 100 that generates the ad tag based upon the winning bid. The ad tag can be, for example, JavaScript code that is enriched with the information gathered during the bidding process. The ad tag may include detailed information on all impressions on the page, including the supported impression sizes, impression markup and custom key-value pairs. The ad tag may also contain the information necessary to render the each ad, which typically includes JavaScript code for calling/rendering an advertisement on a web page but which can take other forms, such as JavaScript, video or in-mobile application advertising, associated tracking codes and pixels. Hence, when the user device's browser or application executes the code contained in the ad tag, an advertisement corresponding to the winning bid is displayed in the web browser along with the requested content. The creative content for the advertisement may come from any suitable source, such as an ad server, the CDS 10, the platform 100, the winning impression providers 300 or combinations thereof; the ad tag is configured so that, when executed by the browser, it causes the user device 200 to pull the creative content of the advertisement from the hosting server and display the creative on the screen of the user device 200. Submission of the ad tag can introduce another latency L4.

The total latency from the webpage request 502 to receipt of the ad tag for the user device 200 is thus on the order of L1+L2+L3+L4; assuming that such latencies are typically about 100 milliseconds each, the total latency would then be about 400 milliseconds. However, this latency does not substantially increase with an increasing number of potential bidders 300, in contrast to the waterfall method in which the latencies increase linearly with the number of bidders. The system 100 can thus support significantly more bidders 300 than would otherwise be feasible with the waterfall method.

With continuing reference to the example of FIG. 3, in certain embodiments, as indicated in relation to step 523, upon determining the winning bid (e.g., AdNetworkB at $1.20), the CDS 10 may use the winning bid to set the floor or reserve price in evaluating other potential advertising. Alternatively, instead of determining (in step 510) whether to conduct an auction or serve a direct sale campaign ad, the winning bid may be compared to the value of one or more direct sale campaigns, with the platform 100 selecting the higher value ad of the auction and direct sales. Such an alternate process will introduce further latencies of L5 and L6 but may result in greater monetization of the impression. The overall winning bid is then used to fill the impression and is submitted as part of the webpage content.

In the various embodiments described herein, the advertising management platform 100 may (but need not) be implement on one or more ad servers, for example, running Linux. The ad server may be implemented as a web service using any multi-threaded language that supports HTTP requests in a manner such that input/output (“I/O”) threads are decoupled from working threads, thereby permitting the various engines of the advertising management platform 100 to use the server CPU resources at full capacity without being restricted by I/O threads. Furthermore, in a specially-programmed embodiment of the platform 100, the platform engines (targeting, floor, bidding, etc.) may use asynchronous parallel processing and a pool of worker threads, each being connected to a bidder in a given auction. Moreover, the bid requests can be provided in parallel using “futures,” while other services are being provided for the subject impression. The platform 100 preferably collects the bid responses within a predetermined timeout, such as from 200 milliseconds to 700 milliseconds, after which the process continues, ignoring bidders from which no response was received before the predetermined timeout. It will be understood that a “future” is an object that acts as a proxy for a result whose value has not yet been calculated. Hence, a “future” can represent a bid that has not yet been received from the bidder 300.

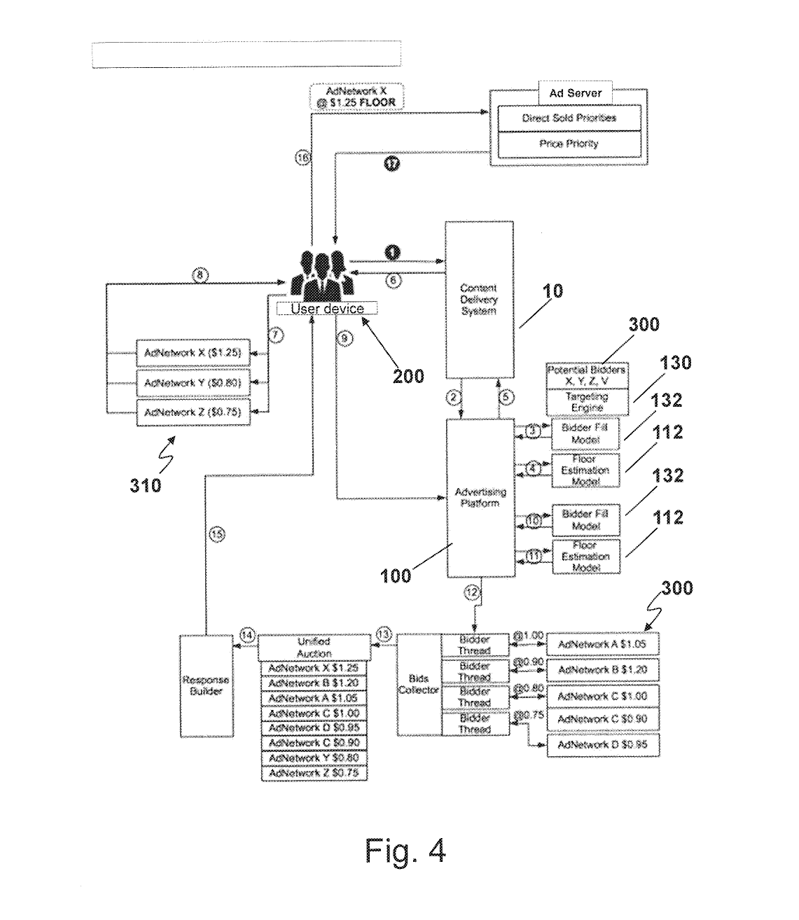

FIG. 4 (with continuing reference to FIG. 1) illustrates an embodiment in which the advertising management platform 100 provides a unified, integrated auction, namely one that supports both client-side header bidding and server-side auction of the advertising management platform 100 using pricing obtained via the client-side header bidding.

Conventionally, in header bidding, the CDS 10 would submit impressions to multiple advertising exchanges before making a submission to their primary ad servers. However, to reduce latencies introduced by such header bidding, it is desirable that the number of advertising exchanges used is kept to a minimum. To facilitate this, in the embodiment system and method depicted in FIG. 4, upon receiving a webpage request from a user device 200, as indicated by encircled step 1, the CDS 10 issues an ad call to the advertising management platform 100, as indicated by encircled step 2, that includes the impression information.

In response to receiving the ad call, the platform 100 determines which header bidders 310 should be used, as indicated by encircled step 3. This decision can be based upon two drivers within the platform 100 (e.g., targeting engine 130): the user-determined rules engine, as set by a campaign manager using the campaign management console or interface to platform 100, and the behavior model or models 132, which, as described above, can be based upon machine-learning algorithms. The targeting engine 130 determines which bidders 310 are more appropriate or desirable (e.g., those bidders 310 likely to submit the highest bids and conformal to the advertising rules) to participate in the header bidder auction. By way of example, if the targeting engine 130 has advertising rules (e.g., set by a campaign manager) to not include Bidder X if the user device 200 is in Germany, then the targeting engine 130 will exclude Bidder X as a header bidder and thus not run a corresponding model 132 for Bidder X. Whereas the advertising rules of the targeting engine 130 can provide course-grained selection and elimination of bidders 310 (e.g., by country, taxonomy data, etc.), the behavior models 132 can make much finer-grained determinations based on, inter alia, features extracted from the ad call and impression information. For example, a behavior model 132 could determine that Bidder X should not be included in impressions originating from New York at LOAM on mobile devices. When multiple header bidders 310, conformal to the advertising rules, are evaluated by the behavior model or models 132, a fixed number of the top highest probable bidders 310, for example, can then be selected for header bidding.

Next, as indicated by step number 4, the platform 100 uses the floor estimation engine 110, and in particular the floor model or models 112, for the selected header bidders 310 to set the floors for their respective bids. The advertising management platform 100 then, in step 5, forwards header bidder information concerning the selected one or more header bidders 310 back to the CDS 10. The header bidder information can include, for example, the selected header bidders 310 to include, impression(s) to bid on for each selected bidder 310, and the floor price for each bidder/impression combination. By way of specific examples to webpages, the header bidder information can be packaged and delivered as part of the JavaScript on the HTML page of the content requested by user device 200. The CDS 10 uses this provided header bidder information to generate a webpage with header bidding code for the selected header bidders 310 and submits this webpage to the user device 200 in step 6.

Continuing with the specific example, in response to processing the header bidding code in the webpage, in step 7 the browser in user device 200 executes the instructions included for header bidding purposes and performs the header bidding in the user device 200 browser for the selected header bidders 310. As illustrated in FIG. 4, such selected header bidders 310 may be AdNetwork X, AdNetwork Y and AdNetwork Z. Then, as indicated in step 8, the results of the header bidding are collected by the user device 200. In step 9, the browser of the user device 200 packages the results and appends them to the ad call discussed above, which can include bid price and the code for rendering the ad unit (termed “ad markup”) to serve. In certain embodiments, to accommodate limitations imposed by the browser of user device 200, only the bid price may be sent to advertising platform 100; the ad markup may be kept in the webpage code of the user device 200.

While the ad management platform 100 is determining the header bidders 310 (or as the browser of user device 200 is making the header bid calls), the ad management platform 100 may simultaneously conduct an auction (if it determines that one is to be performed) generally as described above in connection with FIGS. 2 and 3, as indicated by steps 10 and 11 of FIG. 4, with the addition of integrating the header bidding results received in step 9 into the unified auction (i.e., an auction inclusive of header bidders 310 and competitive bidders 300). Thus, although a new ad call may be used as initiated by the user device 200, in other variations where the platform 100 selected the header bidders 310, the platform 100, in response to the same ad call from the browser used by the ad management platform 100 to select the header bidders 310 also initiates the auction as described above. For example, the platform 100 may initiate both the header bidding and the auction by virtue of the ad call including an indication or instruction to pass back selected header bidders and initiate the competitive auction, as generally described herein. Thus, in one embodiment, upon receiving the initial ad call and impression information from the CDS 10, the platform 100 runs the floor estimation engine 110 and related models 112, and targeting engine 130 and related models 132, against all potential impression providers 300 and header bidders 310 (which may include the same or different potential bidders). In other embodiments, the platform 100 may perform auction optimization for the selected potential impression providers 300 only after receiving the header bidder results in step 9. An advantage of causing the advertising platform 100 to perform auction optimization for the potential impression providers 300 in response to receiving the header bidding results from user device 200 is that the desired content is already delivered to user device 200 from CDS 10 and users typically will wait for advertisements but they will not wait for the desired content. In either case, using the impression information and the profile database 120, the platform 100 performs auction optimization, selecting ad providers 300 to receive bid requests using targeting engine 130, and pricing optimization using floor estimation engine 110 to determine the price floor or reserve for each selected provider 300. In step 12, a bidding engine within platform 100 then issues bid requests to the selected bidders 300, with each bid being processed by their own thread within the platform 100. After completion of the auction (if one is performed), as indicated in step 13, the platform 100 reviews the results of the auction in conjunction with the bidding results from the participating header bidders 310, thus conducting a unified auction. In step 14, the winning bid is then used by the response builder in platform 100 to generate an ad tag that, in step 15, is forwarded to user device 200.

For example, as shown in FIG. 4, the advertising management platform 100 has selected “AdNetwork X,” “AdNetwork Y” and “AdNetwork Z” 310 to receive requests for header bidding purposes. The related header bidder information is sent to CDS 10 to initiate header bidding. The platform 100, based on its auction and pricing optimizations, either in parallel or in response to receiving the header bidding results, generates and sends bid requests to “AdNetwork A,” “AdNetwork B,” “AdNetwork C,” and “AdNetwork D,” with the corresponding floor/reserve prices, as shown. The platform 100 receives header bid responses and auction bid responses, either in parallel or sequentially, depending on the embodiment used. The platform 100 aggregates the header bidder 310 bid responses received prior to the timeout of the auction bidding, which are integrated with the bids timely received from the auction of competitive bidders 300 and, from the aggregated bid responses, determines a winning bid (e.g., subject to any ad quality rules). In the example of FIG. 4, AdNetwork X provides a winning bid of $1.25.

As with the previously discussed embodiment, the winning bid from step 15 may, optionally, then be used to set the floor in yet another auction at another exchange (e.g., by an ad server), as indicated in step 16. The results of this secondary auction are then used to generate an ad tag that is forwarded to the user device 200 in step 17 to render an advertisement associated with the winning bid. It will be appreciated that the platform 100 may generate the ad tag, but the content of the ad tag may come from the associated winning bidder 300. Where no secondary auction is performed, the result of the unified auction is used by the response builder of platform 100 to generate the corresponding ad tag to render an advertisement.

Preferably, the bidding results from the header bidding are used by the advertising management platform 100 as part of the aforementioned feedback and entered into the profile database 120, updating the profile information (e.g., bidding history based on the characteristics of the impression) for the header bidders 310 to which requests were sent. By way of example, the data from both header bidding and the primary auction can be streamed as logs to a log collection system of platform 100. The logs may be aggregated in a data warehousing system to generate traffic information. The logs may also be used by different machine learning models, such as the floor models 112 and the behavior models 132. The logs may also be used for different ad hoc queries to address business needs, such as revenue reporting, bidder activity, etc. The data logs can include, for example, information about the impressions served, the bids from each competitive/header bidder 300, 310 (and the secondary auction, if any) and winning bid for each.

Beyond providing an advertising system for auctioning impressions, various embodiments of the present invention can support the tight integration, and hence control, of both content delivery and advertising, thereby providing whole page optimization. In such embodiments, the functionality of the advertising management platform 100 is integrated with the CDS 10 to maximize not only the value of individual impressions but the total potential value of the webpage (content) to maximize profitability and increase technical efficiency.

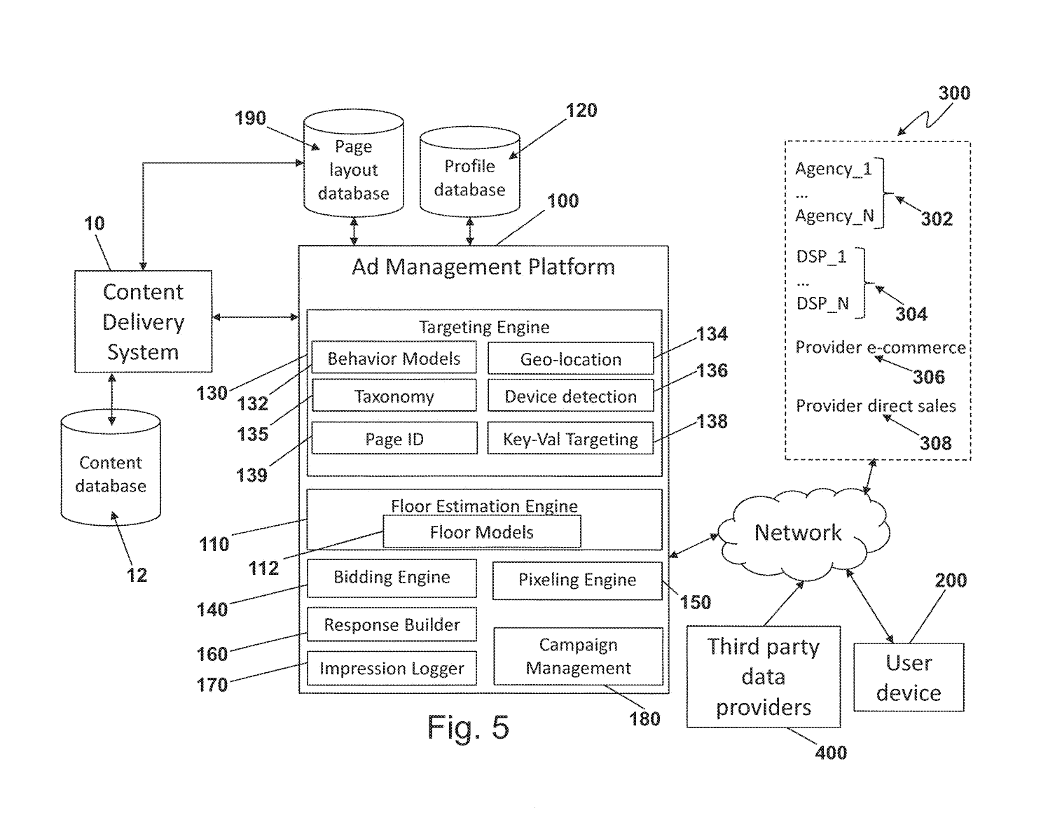

FIG. 5 illustrates one embodiment of the advertising management platform 10 being integrated with the CDS 10. Such integration may be obtained, for example, through the sharing of resources, such as CPUs, databases, communications systems and the like between the CDS 10 and the advertising platform 100. For example, a single code base, running on one or more servers, may provide the functionality of both the CDS 10 and the advertising management platform 100. Alternatively, separate code bases, running on the same or different servers, may respectively provide the functionality of the CDS 10 and the advertising management platform 100, and these code bases may communicate with each other by way of agreed upon application programming interfaces (APIs). In such an embodiment, the CDS 10 and platform 100 may be hosted in the same data center so that call latencies between the two can be relatively reduced, e.g., on the order of 20 milliseconds or less. The advertising management system 100 is integrated into or with the CDS 10 so that prior to the CDS delivering content to the user device 200, the CDS 10 makes, for example, a server-side API call to the ad management platform 100, and the ad management platform 100 returns a template for the content and related advertising units that should be sent to the user device 200, as discussed in the following. Thus, the dynamic determination and serving of the impression is integrated with a dynamic determination of content and/or content template, which is based upon the ad determination. It should be appreciated that integrating the CDS 10 and ad management platform 100, including such dynamic determination of content and/or content template along with determination of the ad(s) to be served, represents not only change in the structure and function of typical CDSs and advertising platforms, but is also a departure from the overall typical functioning of how webpages and advertisements are selected and served on, for example, the Internet.

As shown in FIG. 5, the CDS 10 and advertising management platform 100 may share a page layout (or template) database 190, which is described further below. The ability of the integrated system to store page templates with the advertising management platform 100 provides various advantages, as will become apparent from the following description, including simplification of the page code; providing an ability to make modifications to the ad units without requiring code changes and related deployments on the CDS 10 side; the ability for the platform 100 to know the page layouts supported by the requested page; and the ability for the platform 100 to know the revenue assets supported by the templates. Additionally, if the CDS 10 has its own advertisements that it is interested in placing (e.g., as part of a publisher network), then the impression providers 300 can also include non-competitive offers, such as e-commerce advertisements 306 for the products/services of CDS 10, mobile application downloads, lead generation, membership offers, etc. For purposes of the following, and the sake of simplicity, only e-commerce advertisements 306 are discussed, but it will be appreciated that other non-competitive offers can similarly be used. Similarly, if the CDS 10 has its own direct sales agreements with customers, then the impression providers 300 may also include advertisements from such direct sales customers 308. The advertising management platform 100 may include behavior models 132 and floor models 112 for each potential impression provider 300, and similarly the profile database 120 can hold bid information related to each impression provider 300, including the e-commerce impression provider 306, or other non-competitive offers, and the direct sales impression provider 308.

A webpage, and other types of digital content, may have more than one possible manner of being arranged and formatted to provide the content requested by the user device 200. Each possible format or layout of a webpage (or other content) can be saved as a respective template, and these templates are stored in the page layout database 190 that both the CDS 10 and the advertising management platform 100 can access. Each template may have one or more impressions. For example, one template may have a single, prominent impression in the form of a banner, below which the content in the webpage is presented. Another template may include a plurality of smaller impressions running along the side of the webpage. Yet other templates may include video-based impressions, floating impressions, expanding impressions or the like. It will thus be appreciated that each webpage may include any number of corresponding templates, with the templates including various different possible layouts of impressions within the webpage. In general, the advertising management platform 100 optimizes the auction process, both in terms of technical effect (including speed of selecting and loading the advertisements) and in maximizing yield from the webpage 204.

By way of example, each template may be assigned a unique identifier. As explained in more detail below, the ad management platform 100 selects the template that will yield the most revenue or engagement (depending upon the criteria) and returns the identifier of that template to the CDS 10. In response to the user device 200 requesting content, the CDS 10 may communicate one or more page template identifiers for the requested content to the advertising platform 100. Each page template in the page layout database 190 can have multiple ad units in it that describe all the revenue units (e.g., impressions) on the page, their respective IDs on the page, their sizes, targeting parameters, and any other suitable advertising parameters. The CDS 10 communicates which one or more page templates it supports for the content requested by the user device 200 by sending an ad call to the ad management platform 100 that includes one or more corresponding page template identifiers. The advertising platform 100 returns the identifier of the “winning” page template along with the relevant ad tag information. Alternatively, information about page layout and corresponding pages may be stored in a page layout database 190 that is accessible by the ad management platform 100. The ad management platform 100 accesses the page layout database 190 to lookup page templates associated with user-requested content (e.g., a web page) in response to receiving the ad call from CDS 10. Any other suitable variation may be used to allow the CDS 10 and platform 100 to indicate the one or more templates suitable for the underlying content of the webpage requested by user device 200.

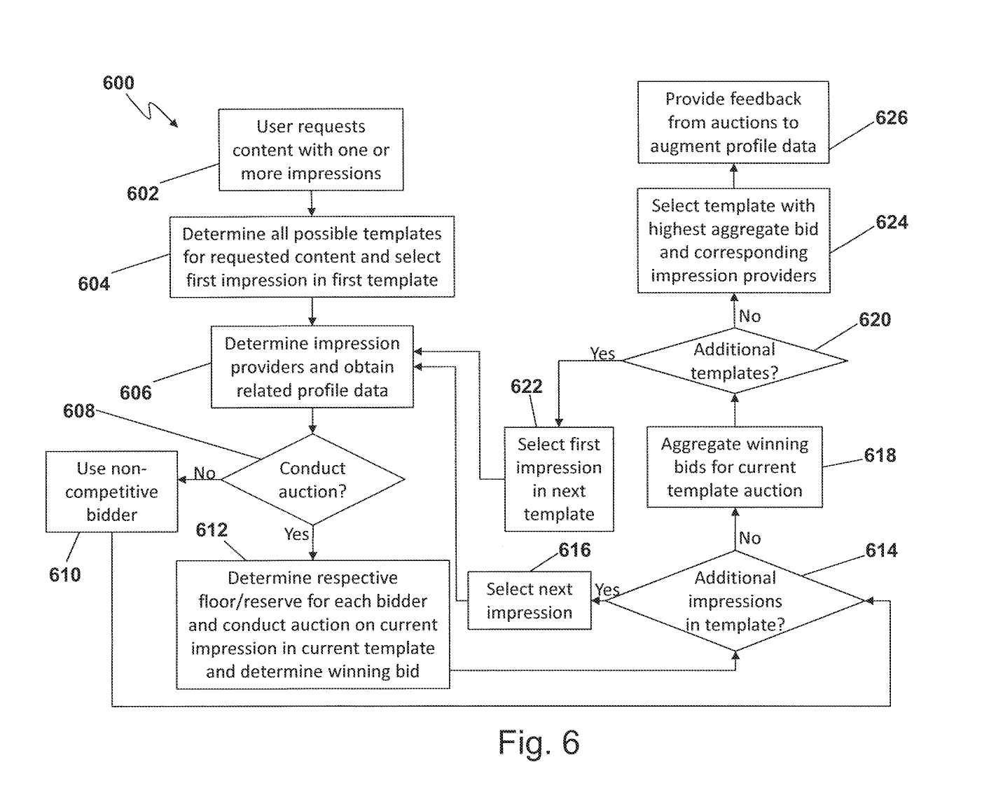

As further illustrated in FIG. 6, which illustrates steps in an integrated embodiment to maximize the potential return for all possible variations (e.g., templates) of a webpage, in step 602 the user device 200 sends a content request (e.g., a webpage request in response to a user selecting a URL in a web browser) to CDS 10. In response to receiving the content request, at step 604 the CDS 10 collects impression information from the user device 200 and provides this impression information to the advertising management platform 100 as part of an ad call. For example, a REST (representational state transfer) Request from the CDS 10 to the advertising management platform 100 can include: page template identifiers; page URL; user device 200 IP address; user device 200 USER_AGENT information; custom key-value pairs; HTTP headers of the browser of user device 200, etc. In step 604, upon receiving the ad call and obtaining the related impression information, the advertising management platform 100 identifies all of the possible templates for the webpage request using the page layout database 190. As noted above, in a specific embodiment, the indication of possible templates for the requested content may come from CDS 10 as part of the ad call; other variations are possible, however, such as lookup tables based upon content URL or identifier, etc. The platform 100 then selects a first template from the possible templates and a first impression within this template. Preferably, as the CDS 10 waits for a response to the ad call the CDS 10 simultaneously begins building the requested webpage. Hence, auctioning and content building can occur in parallel and as an integrated process, thus further reducing latencies.

In step 606 the advertising management platform 100 determines which of the potential impression providers 300 should participate in an auction, including both competitive and non-competitive bidders, and the floor or reserve price for each, using the respective behavior models 132 for the potential impression providers 300. In addition to using the profile database 120 and impression information to perform this analysis, the targeting engine 130 may further utilize information from taxonomy service 135, as previously discussed.

Once the targeting engine 130 has completed running the models 132 for the potential impression providers 300, in step 608 the platform 100 looks at the results from the behavior models 132 and determines whether or not an auction for the impression should be held. In particular, if the behavior models 132 indicate that the greatest expected value for the impression would arise from a non-competitive bidder, such as an e-commerce advertisement 306 or from a direct sale customer 308, then no auction is held and instead the impression is filled by the e-commerce sale 306, by the direct sale customer 308, etc. as the case may be.

By way of example, the impression information may indicate that the user device 200 originates from outside of Texas, and thus the advertising agency 302 is excluded from the auction by its respective behavior model 132. Further, a machine learning model 112 may be used to model the bidding behavior of a DSP 304, and based upon all (or a portion of) historical auction data in the profile database 120 for that DSP 304, as well as information from taxonomy service 135 and user device 200 present in profile database 120 and the impression information, may determine that the DSP 304 is likely to tender a bid of X for the subject impression. Another machine learning behavior model 132 may be used to model content provider e-commerce sales 306, and based upon previous purchases and click behavior of the user device 200 stored in the profile database 120 may determine a potential value of Y on the subject impression. Finally, the behavior model 132 for content provider direct sales 308 may indicate that the impression information is conformal to the contract requirements for the direct sales customer 308 and thus may return a contracted value of Z for the direct sales provider 308. Based upon these respective models 132, if the value of X (expected bid from DSP 304) exceeds the values of Y (expected value of e-commerce sales) and Z (contracted value of direct sales), and assuming that advertising rules are met, then an auction is performed for the impression.

Otherwise, as indicated in step 610, no auction is performed and the impression is filled by the advertisement corresponding to the more valuable of Y and Z. In the latter case, the platform 100 avoids an unnecessary auction and thus is able to immediately fill the impression, thus avoiding any potential delays and resultant losses of the impression that an auction can incur. In the former case, even though an auction is performed, it is performed with a subset of the potential impression providers 300, such as (in this specific example) a single DSP 304 and either the platform e-commerce provider 306 or the direct sales provider 308, thereby significantly reducing the number of participants in the auction and thereby significantly reducing the probability of the auction delaying the filling of the impression.

If an auction is to be performed, then in step 612 the floor estimation engine 110 runs the floor models 112 for the participating impression providers 300 to determine the floor/reserve of each participant 300 in the auction. The platform 100 then issues bid requests to the participants 300 in the auction, which includes the floor/reserve information and the impression information. Some of the participating impression providers 300 may make use of third party data provider systems 400 to better inform their tenders. Such third party data provider systems 400 are known in the art, and are used to gather additional information about the user device 200. It will be appreciated that if non-competitive bidders, such as the e-commerce 306 or direct sales 308 providers, are included in this auction, no bid request need be sent to these non-competitive entities as their respective “bids” have already been computed by the floor estimation engine 110.

The advertising management platform 100 performs an iterative process, determining in step 614 if there are further impressions in the current template, and if so selecting the next impression in the current template at step 616 and then looping back to step 606. On the other hand, if all impressions in the current template have been evaluated, then at step 618 the platform 100 logically aggregates (e.g., stores) the one or more winning bids for the current template corresponding to the one or more impressions in the template, including the non-competitive bids computed by the floor estimation engine 110, such as the e-commerce bids 306 and direct sales bids 308. The platform 100 then determines, at step 620, if there are more templates to consider. If there are more templates to process, then at step 622 the platform 100 selects the next template as the current template, selects the first impression in this new current template and then jumps to step 606 to begin processing the impressions in the new current template.

After all of the possible templates have been evaluated, at step 624 the advertising management platform 100 selects the template with the highest associated potential return as a winning template, and the corresponding one or more winning impression providers 300 for this winning template, to fill all of the impressions in the winning template. Simultaneously, in step 626, impression logger 170, which can run asynchronously, extracts feedback from each of the auctions performed in the above steps to update the profile database 120. This feedback can include, for example, the data for each user device 200. Impression and auction information can be written to a data store, such as profile database 120, and associated together by a unique identifier assigned to each of the records. In this manner, each of the models 112, 132 is also updated, and, in the context of machine learning-based models 112, 132, helps the models 112, 132 to improve with time as more and more data is accumulated in profile database 120.

Alternatively, platform 100 may select as the winning template the template that is expected to yield the most revenue based upon a model built upon historical bid data. Hence, in addition to the models 112, 132, platform 100 may further include a template-selection model that selects a template for use based upon features extracted from, for example, user device 200, bidders 300, the impression information (e.g., the requested webpage, etc.), that can be used to determine the expected or predicted value of all impression associated with a given template, consistent with the models discussed herein. The platform 100 determines and selects, for use in filling the related impressions and generating ad units, the template with the highest expected value. In such embodiments, latency may be further reduced, as alternative auctions do not need to be conducted for each template. Instead, only the auctions needed to fill each impression in the model-selected template are performed.

After the winning template has been determined and the related bids collected, a response builder 160 generates related advertising information concerning the respective advertisements of the winning impression providers 300, and this advertising information is then provided to the CDS 10. The advertising information can include, for example, ad tags that the CDS 10 can insert into the webpage to cause the browser of the user device 200 to load the respective advertisements, a universally unique identifier (UUID), tracking pixels, geolocation information, user device 200 information, operating system information, browser type, taxonomy information, page identifier, creatives, custom key-values, HTML Head information, and HTTP header information. For example, a REST Response from the advertising platform 100 to the CDS 10 can include: a unique ID of the request; information about the server who replied to the request; a timestamp of the request; geographical location information, including country, state, DMA, area code, city, postal code and time zone; user agent information, including operating system, browser and device type; a list of categories for the page; a unique page ID based on the URL; a list of pixel objects to drop on the page; a list of creative objects; an HTTP div ID where the advertisement should be injected; the width of the ad unit; the height of the ad unit; a markup to put in the ad unit; custom key value pairs set at the creative level; an unique ID of the creative; a unique ID of the advertiser; a campaign ID; and a JavaScript render that will render this object.

The CDS 10 uses the winning template page layout database 190, desired content from content database 12, and the ad tags obtained from the advertising management platform 100 to generate content that is then served to user device 200.

In certain embodiments, the platform 100 may also provide, with the ad tag, a header tag. The header tag can be, for example, a static file that includes any helper functions needed. The ad tag can be the primary tag that is rendered to deliver the winning advertisement(s) (creative(s)) into the webpage. The response builder 160 can include a macro substitution engine that allows for better integration with JavaScript code on the delivery platform side 100. For example, the macro substitution engine can be based on syntax that exposes the platform adserver context. In particular, the use of ${DEVICE_TYPE}, ${COUNTRY}, ${REQUEST_ID} and other macros can be used in JavaScript served by the platform adserver. In addition, the macro substitution engine may also add functions in addition to performing macro substitution. For example, one possible function is an “Abbreviation” function, which abbreviates the value of the macro to a predetermined maximum length; another function can be “BASE64,” which takes the content of the macro and Base64 encodes it, e.g.: ${URL:BASE64}. Of course, other functions are also possible.

Because auction speed is important, in certain preferred embodiments the auctions are performed in parallel. Hence, although the above loops are described as being serial in their execution, in practice these loops can be “unwound” to execute asynchronously. Preferably, the machine learning models 112, 132 do not require out of process calls in order to make real-time evaluations of floor estimation, bidder behavior, etc. This provides an advantage in reducing the latency of model evaluations, and can provide an advantage over, for example, systems that make remote function calls for model evaluation, as such systems can be limited by the number of remote calls they can make at any given time.

Preferably, the advertising management platform 100 is designed to support parallel bidding of impressions, such that the same impression may be simultaneously bid upon across N auctions corresponding to N possible template variations for that impression. Simultaneously, each impression in a template may be bid upon in parallel. As a result, the total number of auctions performed in parallel may be as high as the product of the number of impressions with the number of templates. In practice, however, the value may be lower, as the targeting engine 130 may exclude some impression providers 300 from some auctions. As a result of this parallel processing of the auctions, the entire auctioning process across multiple impressions and multiple templates can occur in substantially the same amount of time as is required for an auction for a single impression.

The advertising management platform 100 can include a pixeling engine 150 that determines tracking pixels that should be dropped on the webpage served to user device 200 and appends these pixels in the advertising information. Additionally, platform 100 may include a campaign management module 180 that allows a campaign manager for CDS 10 to manage advertising campaigns, such as setting flight dates, frequency capping, limits, geographical targeting, quality score (QS) targeting, URL/domain targeting, device targeting, key-value targeting, controlling the pixeling engine 150, etc. The campaign management module 180 can also provide a user (e.g., system operator) interface for the targeting engine 130, including settings for the advertising rules previously discussed. By way of example, factors that the campaign management module 180 can use to allow a campaign manager to control an advertising campaign can include: priority, which can be a numeric value to indicate which campaign is executed first; pace, which allows a campaign to run a percentage of the time it is called; flight dates, which control a time range (e.g., hours of the day, certain week days, etc.) that a campaign runs; and advertising rules, which can be based on parameters such as device type, operating system, browser, countries, states, cities, page URL, query string in the URL, site, impression size and ad unit type (e.g., popup, floating, video, audio, etc.). In support of this, the targeting engine 130 can further include, for example, a geo-location module (code) 134 to assist in determining the geo-location of user device 200, a device detection module 136 to assist in the detection of the device type of user device 200, a key-value targeting module 138 for manual override of targeting or sending specific targeting criteria to be passed to an ad server subsequent to the auction, and a page identification module 139 for selecting possible templates for a page or unit of content from the page layout database 190. For example, if a targeting rule has been set up manually in the campaign management module 180, the key-value targeting module 138 can override the targeting decision that would normally made by the ad server of the platform, and this targeting is passed over to the ad server as a key-value pair.

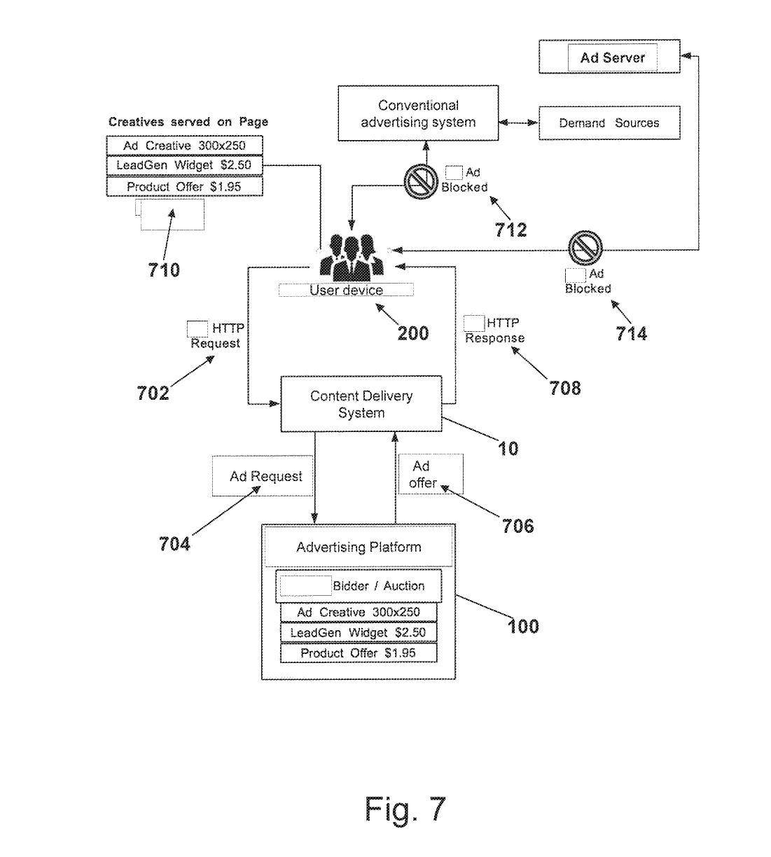

One benefit of integrating the advertising management platform 100 with the CDS 10 is that it enables the CDS 10 to overcome adblocking software on the user device 200. Ad blocking software is known in the field and can present a significant threat to CDSs 10. This ability to avoid adblocking software on the user device 200 is illustrated in the embodiment of FIG. 7. In FIG. 7, in step 702 a user device 200 issues a webpage request to CDS 10. In response, at step 704 the CDS 10 issues an ad request to the platform 100, and the platform 100 responds at step 706 with an ad offer. The steps performed by platform 100 in generating the ad offer can be substantially the same as those in generating ad tags and/or advertising information discussed above, but the ad offer preferably includes the creative(s) for the ad unit(s). For example, as indicated in FIG. 7, the platform 100 may have determined that, for example, a template having a creative from an advertising agency 302, lead generation offer for the CDS 10 and a product offer, presents the highest return for this webpage request, and thus presents these creatives to the CDS 10 as part of the ad offer in step 706. Using this ad offer, the CDS 10 generates a webpage having the creatives directly included in the desired webpage content. The webpage containing these embedded creatives is then served in step 708 to the user device 200, and as a result the creatives are served “natively,” as part of the content delivered with the web page. In rendering the desired content, the user device at step 710 also necessarily renders the creatives (i.e., as part of the content), thus avoiding ad blocking. For example, platform 100 can cause a piece of code, such as JavaScript code, to be inserted into the webpage that identifies and evaluates the creative associated with an ad offer returned by the advertising platform 100 and renders it in the webpage displayed on user device 200. Ad blockers are thus foiled because the advertisements are presented using computer code that makes them indistinguishable to the ad blocker from the desired content. Additionally, the advertising management platform 100, CDS 10 or both may utilize polymorphic formatting for the web content, which alters the pattern of the content HTML on every impression in the web content so as to be unrecognizable or obfuscated by the ad blocking program.

In contrast, as shown in steps 712 and 714, when fulfillment of creatives originates from a conventional advertising system or other ad server, ad blocking software is able to identify the underlying ad tags for what they are and block the creatives. This, however, is significantly more difficult to do when, with the integrated CDS 10 and advertising platform 100, the creatives are integrated with the desired content itself, as described above.

Any suitable collection of hardware and software implementing the features described herein may be used to implement the various embodiments of advertising management platforms. Preferably, the advertising management platform 100 is implemented as a collection of computing units or servers that are networked together to facilitate load balancing. Each computing unit may include one or more processors, networking hardware, memory and program code stored in the memory. The program code is executable by the processors to cause the computing units to perform the various steps, features and functions set forth above, thus causing the computing units to operate as specially-programmed devices. Providing such program code is well within the abilities of a person having ordinary skill in the art after reading the instant disclosure. Additionally, the platform 100 may include database servers to support, for example, the profile database 120 and page layout database 190.

Preferably, the platform 100 is designed to make no conventional database calls during processing of an impression. Instead, in preferred embodiments, all data required for the processing of an impression is stored in computer memory (RAM) for fast access, such as decision models 112, 132, bidder 300 information, etc. However, one exception to this can be the looking up of data in the profile database 120 for information related to user device 200. Such information is preferably obtained by way of a database call prior to the collection phase of the real-time bids. To achieve reduced latencies for database calls, a key-value store is used containing all data necessary to carry out the auction and display of the related advertising. As understood in the field, a key-value store, or key-value database, is a data storage paradigm designed for storing, retrieving, and managing associative arrays; in this case, the data can be stored in memory.

Various embodiments of the platform 100 are configured to achieve high throughput and low latencies. For example, as previously discussed, on the network side the platform 100 can use software libraries that allow separation of the network threads from the processing threads to effect non-blocking I/O. For example, two thread pools can be implemented, with one for network processing and the other for data processing. Network threads process requests at the network level and deliver the requests to the data processing threads that then processes the requests more in-depth and return back to the original network threads to return the response. Such a threaded arrangement of the underlying code allows for better scalability, since network threads are free to accept requests while data processing threads are busy processing the requests. Similarly, as previously discussed, in the bidding engine of the platform 100 can use multiple threads to make remote calls to bidders, which can enable the platform 100 to scalably push requests to each bidder and then actively wait for a certain number of milliseconds for all bidders to reply and collect the bids that are ready.

Additionally, to ensure high availability, the advertising platform 100 is preferably distributed over a plurality of datacenters, continents or both. For example, one set of servers could be in the east coast of the United Stated, another set in the west coast of the United States and yet another set in Europe. This arrangement ensures that the platform 100 should serve impressions even if one or two data centers are compromised. Preferably, the platform 100 supports any suitable or known geographical load balancer that recognizes traffic patterns and redirects users to the closest server in terms of latency, thus reducing serving latency.

Certain embodiments of the advertising platform 100 may be configured to follow the execution of an impression and to report on latency in the underlying code. In particular, the program code may be designed to support a pipelined framework. Under this framework, each pipe latency can be measured and reported upon, for example, in the aggregate. This can allow managers of the platform 100 to check on the internals of software components of the underlying code between releases and isolate bottlenecks and problems. By way of example, each pipeline can support an “execute” function that executes the task of the pipeline and which is stateless. The result of the pipeline can be carried from one pipe to the next. In particular, the underlying program code can be organized so that each pipe can be moved around simply by changing the configuration without any underlying code changes. Each pipeline preferably keeps track of the time it takes for each call to enter and exit the pipe. This data can then be collected and stored for later analysis. For example, the collected data can be used to quickly detect abnormal latencies and pinpoint the responsible pipe.

Those skilled in the art will recognize that the present invention has many applications, may be implemented in various manners and, as such is not to be limited by the foregoing embodiments and examples. Any number of the features of the different embodiments described herein may be combined into a single embodiment, the locations of particular elements can be altered and alternate embodiments having fewer than or more than all of the features herein described are possible. Functionality may also be, in whole or in part, distributed among multiple components, in manners now known or to become known.

It will be appreciated by those skilled in the art that changes could be made to the embodiments described above without departing from the broad inventive concepts thereof. It is understood, therefore, that this invention is not limited to the particular embodiments disclosed, but it is intended to cover modifications within the spirit and scope of the present invention, including the combination of features in different embodiments into a single embodiment. While there has been shown and described fundamental features of the invention as applied to being exemplary embodiments thereof, it will be understood that omissions and substitutions and changes in the form and details of the disclosed invention may be made by those skilled in the art without departing from the spirit of the invention. Moreover, the scope of the present invention covers conventionally known, future developed variations and modifications to the components described herein as would be understood by those skilled in the art.

What is claimed is:

1. A computer-implemented method for providing digital content to a user device, comprising:
receiving over a network, by a computing platform comprising a server having one or more processors, from a content delivery system, an ad call associated with an impression for a webpage requested by the user device, said receiving further comprising receiving impression information based on the ad call;
selecting, by the computing platform implementing one or more behavior models, from a set of potential impression providers, a subset of potential impression providers, based on first features from at least one of the impression information, profile information stored in a profile database, and taxonomy information provided by a taxonomy service, wherein each behavior model runs asynchronously within its own thread or process, and is associated with a single potential impression provider, a class of potential impression providers, or a specific user device;
determining, by the computing platform implementing one or more floor models, a floor or reserve price for each potential impression provider in the subset, based on second features from at least one of the impression information, the profile information, and the taxonomy information, wherein each floor model runs asynchronously within its own thread or process;
generating and transmitting over the network, by the computing platform, bid requests to potential impression providers in the subset in parallel, each bid request comprising the floor or reserve price determined for the respective potential impression provider, wherein the computing platform allocates multiple threads and each bid request runs in its own thread, each bid request thread handling the sending of the respective bid request and the receiving of a related bid response;
determining, by the computing platform, a winning bid from a plurality of bid responses received responsive to the bid requests, each bid response including related advertising information;
creating, by the computing platform, an ad tag based on the winning bid and the related advertising information; and
transmitting the ad tag over the network, by the computing platform, to the user device to be included in the webpage.

2. The method of claim 1 wherein the selecting the subset of potential impression providers and the determining the floor or reserve price for each potential impression provider in the subset run in parallel as separate threads or processes on the server.

3. The method of claim 1 wherein the selecting the subset of potential impression providers and the determining the floor or reserve price for each potential impression provider in the subset are integrated into a single model for one or more potential impression providers.

4. The method of claim 1 wherein the behavior model for each potential impression provider determines at least one of a probability that the potential impression provider will bid on the impression and an estimated bid amount.

5. The method of claim 1 wherein bidding data from a selected percentage of the impressions is used to train the behavior models and the floor models for a remaining percentage of the impressions.

6. The method of claim 1 wherein the computing platform implements a behavior model for the user device to estimate a potential value of the user device in filling the impression with an offer from a non-competitive source.

7. The method of claim 1 further comprising updating the profile database with auction information and the impression information, the auction information including the bid responses, the winning bid, and data for the user device.

8. The method of claim 1 further comprising:
determining, by the computing platform implementing one or more behavior models, based on the impression information, an expected value of a non-competitive bid for the impression; and
using the non-competitive bid as the winning bid if the expected value of non-competitive bid exceeds revenue expected from an auction using the subset of potential impression providers.

9. The method of claim 8 wherein the non-competitive bid comprises a direct sales advertisement, an e-commerce sales advertisement, or a lead generation offer.

10. The method of claim 1 wherein determining the winning bid comprises:
determining a highest bid from the received bid responses;
using the highest bid to set a floor or reserve price in a secondary auction; and
using results from the secondary auction to determine the winning bid.

11. The method of claim 1 further comprising:
using the impression information to select one or more potential header bidders for the impression;
causing, by the computing platform, code to be provided to the user device to be used in connection with requesting bids for filling the impression from the potential header bidders, the code including an indication of the potential header bidders, and an indication of where to send any responses to the header bid requests;
receiving, in accordance with the indication of where to send any responses to the header bid requests, responses to the header bid requests;
wherein determining the winning bid includes determining the winning bid from bid responses received from both the potential impression providers and the potential header bidders, thereby performing a unified auction.

12. The method of claim 11 wherein determining the winning bid comprises:
determining a highest bid from the bid responses received from both the potential impression providers and the potential header bidders;
using the highest bid to set a floor or reserve price in a secondary auction; and
using results from the secondary auction to determine the winning bid.

13. The method of claim 1 wherein determining the winning bid comprises:
determining a highest bid from the received bid responses;
using the highest bid to set a floor or reserve price in a secondary auction of non-competitive impression providers and expected values of the non-competitive impression providers; and
using results from the secondary auction to determine the winning bid.

14. The method of claim 1 further comprising:
identifying, by the computing platform, multiple potential templates for the webpage content, the templates including at least a first template having one or more impressions and a second template having one or more impressions, the first template being different from the second template;
determining, for each potential template, an aggregate potential value;
selecting one of the potential templates based on comparing the aggregate potential values of the potential templates;
generating a content description according to the selected potential template, the content description including the at least an ad tag; and
providing the content description to the user device for rendering the content and at least one ad corresponding to the ad tag, wherein creating the ad tag is based on the one or more impressions in the selected potential template.

15. The method of claim 14 wherein:
determining the aggregate potential value for each of the potential templates further includes, for each impression in the respective template, determining an expected value of any non-competitive impression providers for the impression; and
wherein determining the winning bid comprises using the received bid responses and any determined expected values of non-competitive impression providers.
